(19) United States
(12) Patent Application Publication
(10) Pub. No.: US 2026/0349811 A1
(43) Pub. Date: Nov. 5, 2026

(54) METHOD AND SYSTEM FOR ACCELERATED COMPUTER PROCESSING

(71) Applicants: Geetesh More, Fredericton (CA); Suprio Ray, Fredericton (CA); Kenneth B. Kent, Fredericton (CA)

(72) Inventors: Geetesh More, Fredericton (CA); Suprio Ray, Fredericton (CA); Kenneth B. Kent, Fredericton (CA)

(21) Appl. No.: 19/197,550

(22) Filed: May 2, 2025

(51) Int. Cl. G06F 9/50

(52) U.S. Cl. CPC G06F 9/5027

(57) ABSTRACT

A method for configuring a compute resource and a configurable compute resource for accelerating the running of software code, the compute resource comprising a central processing unit (CPU), a filed programmable gate array (FPGA), the method including the steps of executing on the CPU a simulated running of the software code using a test dataset, a semantic analysis algorithm to identify functions in the software code, a machine learning algorithm to identify feature types present in the functions, and based on the feature types present, flagging the functions as either FPGA-suitable or CPU-suitable, where the FPGA-suitable functions are the most compute-intensive of the functions.

### FIELD

The present invention is generally directed toward the field of computer processing, particularly the use of CPU architecture and field-programmable gate arrays (FPGAs) for computer operations.

### BACKGROUND

Indexes in database systems such as B-trees and hash tables are designed for fast data retrieval. These are created on columns of a table and serve as a pointer to map a key to the position of a record on a table. Much research has been conducted on topics related to a faster index. A learned index is one such area of study. Learned index approaches can achieve significant performance improvement over traditional indexing techniques. However, query performance with learned indexes is limited by the constraints imposed by the CPU architecture.

As data volumes continue to rise rapidly, the demand for high-performing database systems that can deal with “big data” efficiently has also grown. Finding a data item (e.g., record or tuple) based on a key is critical in database systems. Efficient data structures, such as B-trees, hash tables, and Bloom filters, are used as index structures in database systems to determine the position of a queried data item within a large data table.

However, these index structures do not consider the underlying data distribution. Researchers have demonstrated that by knowing the properties of the data distribution, significant improvements can be made in the efficient key lookup. This has led to the incorporation of machine learning (ML) techniques for faster key lookups in relational databases. The resulting index structure, known as learned index [8], implements a cumulative distribution function (CDF) based on the sorted keys of the input data (e.g., a table column) using various ML techniques. The goal of the learned index is to use a model of the input key distribution to build an index tailored to the input keys. In recent years, several learned indexes have been proposed [4, 5, 8, 11]. These models primarily consist of two stages: build and lookup. The build operation in any learned index is essential as it lays the foundation for the key lookup stage. The resulting efficient indexing structures from the build stage are then used to lookup keys.

Existing learned index structures support models such as interpolation, linear regression, or two-layer fully connected neural networks. However, due to CPUs' low concurrency, they cannot efficiently process many queries. The aforementioned CPU limitation can be overcome by accelerating a learned index on a field-programmable gate array (FPGA).

In a relational database management system (RDBMS), such as PostgreSQL, indexes are used for fast retrieval of data. Various efficient data structures such as B-trees, hash tables, and Bloom filters, have been deployed. These structures use indexing to determine the position of some object within a larger data structure. A typical query in SQL on a search on sorted data (SOSD) dataset is shown in Listing 1.

Listing 1: Sample SQL commands to create a table
sosd_dataset_fb, create an index sosd_fb_{—}
index on column value, and a query on the created table.

| | |
|---|---|
| 1 | CREATE TABLE sosd_dataset_fb ( |
| 2 | id INT PRIMARY KEY, |
| 3 | value character(64) |
| 4 | ); |
| 5 | /*Insert data from the SOSD dataset: fb*/ |
| 6 | CREATE INDEX sosd_fb_index ON |
| 7 | sosd_dataset_fb USING B+TREE(value); |
| 8 | SELECT * |
| 9 | FROM sosd_dataset_fb |
| 10 | WHERE value=‘12298204682441981952’; |

First, a table sosd_dataset_fb with two columns: id and value, is created based on the SOSD dataset [9] fb_200M (lines 1-4). After inserting the data from the input dataset (line 5), an index is built based on the user-specified index structure (B-tree is selected by default) on the column value (lines 6-7). In the lookup stage, a query will select all data from the created table where the value matches the input key (lines 8-10). Recently, research based on machine learning (ML) models (such as deep learning models) has given rise to new directions called learned indexes [8].

One sub-stage in learned-indexes that has been researched is Key-Value Store (KVS). Cho et al. [3] talk of implementing FPGA-based KVS using Bloom Filter, With their hardware and data set size of 105, the experiment consumed nearly 13% BRAM and 14% LUT on an FPGA and was able to achieve 2.5× speedup as compared to a software only approach. However, the main challenge with their approach is handling the case when multiple keys map to the same hash index (which is called a hash collision) while maintaining consistent throughput levels. In another related work on FPGA-based KVS, István et al. [6] allocated fixed space to store the colliding keys contiguously in a bucket so that the keys can be read in a burst from off-chip memory. The keys read from memory can be compared in parallel in FPGA logic by using multiple parallel comparators. However, there is a bottleneck in this approach. Allocating a fixed storage space results in higher memory utilization (off-chip and on-chip memory) if a small number of keys map to the particular hash index.

However, there have been a few works where different database operations were accelerated with FPGAs. Qiao et al. [12] presented an FPGA-based sorting algorithm that used a total of 32 HBM channels as off-chip resources in addition to on-chip resources to sort nearly 4 GB of data on an FPGA. In a similar related work, Samardzic et al. [14] implemented a merge-sort algorithm on Amazon AWS F1.2×large instances [1] that use a Xilinx Ultrascale FPGA as an on-chip resource and four 16 GB DDR4 memory banks as an off-chip resource. Memory bandwidth can easily become a bottleneck with the latter DDR-based FPGA approach while the HBM-based FPGA approach requires much tweaking and optimization before significant throughput can be obtained.

Another research project related to interpolation modeling on FPGAs was conducted by Zhang et al. [15]. They modeled different interpolation techniques on FPGAs with their hardware-only architecture. The paper discusses optimizing the DSP utilization, however, it does not mention the dataset size and the number of DSPs used on the FPGA or memory resources used (both on-chip and off-chip memory). In similar related work, Zhang et al. [15] proposed an FPGA-based fast lattice model for piecewise linear function and a multi-linear regression model. However, they tested their model on a very small dataset of size 5000. As such, the on-chip resource bottleneck did not pose any issues for them. In another research project, Qiu et al. [13] proposed a CPU-FPGA-based key-value store (KVS) architecture for storing key-value information during operation such as PUT and GET. Their architecture uses Xilinx Kintex UltraScale FPGA and onboard 2 GB DDR4 DRAM resource and two 10 GbE interfaces and off-chip DDR4 for storing the hash table.

However, prior art approaches to accelerating database operations suffer from on-chip resource bottlenecks, and must rely on additional off-chip memory, such as high bandwidth memory (HBM).

### SUMMARY

The present disclosure according to one aspect relates to end-to-end learned index acceleration with FPGAs. FPGAs offer a suitable alternative to a CPU-based implementation by offering energy efficiency and potentially better performance. According to one aspect, the present disclosure relates to a method that considers the advantages of the learned index and FPGAs. The present inventors, in one aspect, refer to the method as Selective Mathematical Operation AcceleRaTion (SMART) using an FPGA for an end-to-end acceleration of learned indexes. Being a hybrid method between a CPU approach and an FPGA approach, the SMART method of index acceleration achieves higher throughput than the CPU-based implementation while maintaining the data structure storage on the CPU. In one aspect, the SMART method accelerates a radix spline (RS) learned index using a single FPGA without any off-chip memory resources. The resulting index, referred to by the present inventors as SMART-RS, achieves an overall speedup of 5.5× as compared to a CPU-based RS index on the SOSD benchmark datasets.

In another aspect of the present disclosure, the SMART approach intelligently identifies specific compute-intensive operations, avoiding the need for a full-scale FPGA implementation, which would be intricate and time-consuming. The present method reduces the complexities associated with debugging Register Transfer Level (RTL)-related issues, which is advantageous. The present method also offers significant advantages, including controlled on-chip and off-chip memory resource usage while ensuring acceleration.

In another aspect, the present disclosure relates to a method for configuring a compute resource for accelerating the running of software code, the compute resource including a central processing unit (CPU), a field programmable gate array (FPGA), the method including the steps of executing on the CPU a simulated running of the software code using a test dataset, a semantic analysis algorithm to identify functions in the software code, and a machine learning algorithm to identify feature types present in the functions, and based on the feature types present, flagging the functions as either FPGA-suitable or CPU-suitable, where the FPGA-suitable functions are the most compute-intensive of the functions. In another aspect, the method further includes outputting to a user the flagging of the FPGA-suitable and CPU-suitable functions. In a still further aspect, the method further includes configuring the FPGA to execute at least one of the flagged FPGA-suitable functions. In a still further aspect, the method further includes executing on the at least one of the flagged FPGA-suitable functions. In a still further aspect, the method further includes executing on the CPU all flagged FPGA-suitable functions not being executed on the FPGA, and the CPU-suitable functions. In a still further aspect, in the method, the feature types include an arithmetic operation and a looping operation. In a still further aspect, in the method, the at least one of the flagged FPGA-suitable functions executed on the FPGA is an FPGA-suitable function wherein the arithmetic operation is present and the looping operation is not present. In a still further aspect, in the method, the at least one of the flagged FPGA-suitable functions executed on the FPGA is an interpolation function. In a still further aspect, in the method, the software code is for an application selected from the group consisting of a learned index, a learned join, a lightweight learned join, a learned join open, a compression-based index and a database query acceleration.

In another aspect, the present disclosure relates to a configurable compute resource for accelerating the running of software code, the compute resource including a central processing unit (CPU), and a field programmable gate array (FPGA), where the FPGA is configured to execute at least one of the flagged FPGA suitable functions according to one or more of the aspects above.

### BRIEF DESCRIPTION OF THE DRAWINGS

Embodiments of the present invention will be described with reference to the accompanying drawings, wherein like reference numerals denote like parts, and in which:

FIG. 1 is a flow-chart of an FPGA-based on-chip RS index (SMART-RS) architecture. SMART-RS_{Build} is the SMART approach-based build stage, while SMART-RS_{Lookup} is the lookup stage;

FIG. 2 is a diagram of a greedy spline approximation with given error corridor [10]. Spline Points B and C are added to a resultant spline R depending on the orientation: clockwise (CW), counterclockwise (CCW), or collinear. [10];

FIG. 3 is a diagram of RS_{Build} Profiling: Runtime comparison of different operations inside the radix spline Build stage;

FIG. 4 is a logic implementation with the pipelining SMART-RS_{Build-interp} model;

FIG. 5 are bar graphs of SMART-RS_{Build} VS. CPU-RS_{Build} vs. CPU-PGM_{Build} and performance metric;

FIG. 6 are bar graphs of SMART-RS_{Lookup} VS. CPU-RS_{Lookup} VS. CPU-PGM_{Lookup} performance metric;

FIG. 7 is a bar graph of SMART-RS_{Build} over CPU-RS_{Build};

FIG. 8 is a bar graph of SMART-RS_{Lookup} over CPU-RS_{Lookup};

FIG. 9 is a flow chart of steps for FPGA-based optimization;

FIG. 10 is a table of data collected post profiling,

FIG. 11 is a table of Input Data with labeled output for training of ML-model;

FIG. 12 is a table of final decision-making values;

FIG. 13 is a bar graph of profiling and ML model results; and

FIG. 14 is a block diagram depicting an exemplary embodiment of a compute-system which can be used to accelerate computer processing.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

The present invention, in one embodiment, relates to the SMART method of index acceleration for accelerating a radix spline learned index to generate a resulting index, a RadixSpline index or SMART-RS for short. Table 1 explains notations used in the following sections of the present disclosure.

TABLE 1

| Notation | Representation |
|---|---|
| SMART | Selective Mathematical operation AcceleRaTion. Accelerate |
| | compute-intensive operations selectively. |
| SMART-RS | SMART approach-based complete RadixSpline Architecture |
| | involving the CPU-based processing as well as FPGA-based |
| | acceleration of Build and Lookup stage. |
| SMART-RS_{Build} | Wrapper for the Build stage of RadixSpline. This involves the CPU- |
| | based processing and FPGA-based acceleration of interpolation |
| | operation in Build stage. |
| SMART-RS_{Build-Interp} | FPGA-based acceleration of interpolation operation in Build stage. |
| SMART-RS_{Lookup} | FPGA-based acceleration of Lookup stage of RadixSpline. |
| FPGA-RS_{Build} | FPGA-based acceleration of complete Build stage of RS index. |
| CPU-RS | CPU-based RadixSpline implementation[7] |
| CPU-RS_{Build} | CPU-based RadixSpline build stage implementation[7] |
| CPU-RS_{Build-Interp} | CPU-based RadixSpline interpolation operation in Build stage. |
| CPU-RS_{Lookup} | CPU-based RadixSpline build stage implementation[7] |
| CPU-PGM | CPU-based PGM implementation[4] |
| CPU-PGM_{Build} | CPU-based PGM build stage implementation[4] |
| CPU-PGM_{Lookup} | CPU-based PGM lookup stage implementation[4] |

The present inventors refer to the build model and accelerated interpolation function of a learned index as SMART-RS_{Build} and SMART-RS_{Build-Interp}, respectively. Details of the architecture are explained in the section below entitled RS Index Acceleration With FPGA.

The present invention, in another embodiment, relates to a method following the accelerated build model (SMART-RS_{Build}) for accelerating the lookup operation of a learned index for querying. The lookup operation method involves querying over a radix table, where the index is a pointer to a spline point. Finally, the input query point is queried over the truncated search bound returned by an FPGA as an output. The present inventors refer to lookup acceleration on an FPGA as SMART-RS_{Lookup}.

The present inventors compare the present SMART-RS learned index with two prior art CPU-based indexes CPU-RS and CPU-PGM [7]. Note that the prefix CPU indicates that the prior art indices are run entirely on a CPU. The experimental evaluation was conducted with the SOSD benchmark [9]. The experimental results suggest that both the build stage (SMART-RS_{Build}) as well as lookup stage FPGA-based accelerator (SMART-RS_{Lookup}) perform significantly faster than the CPU-RS model without any additional off-chip memory and with a single FPGA device. The best result achieved with the present SMART-RS model is the performance speedup of 5.5× over the CPU-RS model. In one embodiment, the present method relates to the build and lookup operations with minimal updates to a dataset.

RS Index Acceleration with FPGA

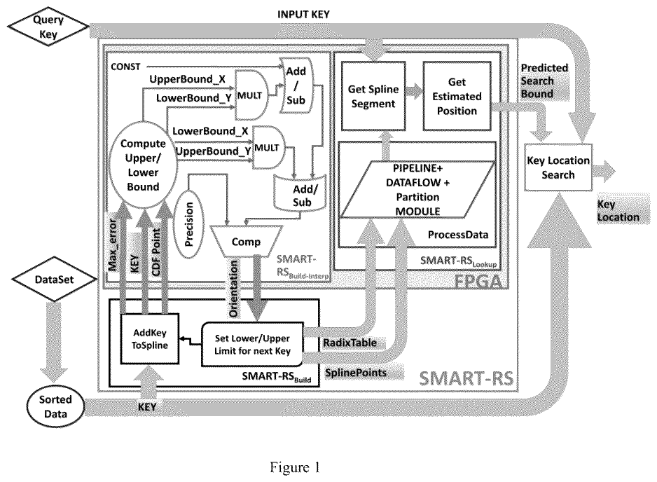

After giving a brief introduction to spline, SMART-RS architecture according to an embodiment of the present invention is presented (see FIG. 1) with FPGAs and an FPGA-based quantitative model is set up to evaluate the speedup of the SMART-RS_{Build} and SMART-RS_{Lookup} compared to the build and lookup performance with the CPU-PGM and the CPU-RS learned index models.

### Introduction to Spline

Splines, owing to their efficient representation and smooth estimation with error guarantees, are used for determining the compressed representation of datasets with accurate estimations. For an unknown function ƒ(x), where x is an independent variable, a function S(x) is called a spline function [2] if it satisfies the following properties:

S(xi)=ƒ(xi) for i=0,1,2, . . . ,n−1.

On each sub-interval [xᵢ,xᵢ₊₁] where i=0, 1, 2, . . . , n−1, S(x) is a polynomial of degree K.
S(x) and its first (k−1) derivatives are continuous on (x₀,xₙ).

RadixSpline constructs the linear spline approximation within a given error bounds (upper and lower) and thereby minimizes the size of these bounds using the linear spline approximation again. A function S(x) is called a linear spline function [2] if it satisfies the following properties:

S(xi)=ƒ(xᵢ) for i=0,1,2, . . . ,n=1.

On each sub-interval [xᵢ,xᵢ₊₁] where i=0, 1, 2, . . . , n−1, S(x) is a polynomial of degree 1.

S(x) is a continuous function on (x₀,xₙ).

In a linear spline approximation, each function is a straight line connecting two data points, (xᵢ, ƒ(xᵢ)) and (xi+1, ƒ(xᵢ₊₁)) in the sub-interval [xᵢ,xᵢ₊₁]. The equation for linear spline approximation between these two points is given by Equation 1:

si(x)=ai+bi(x−xi) (1)

Where for i=0→(n−1),

$${a}_{i} = f ( {x}_{i} ) ; \\ {b}_{i} \frac{f ( {x}_{i} + 1 ) - f ( {x}_{i} )}{{x}_{i + 1 - {x}_{i}}} ;$$

However, linear splines are not smooth and suffer from discontinuity between them. To overcome this deficiency and ensure smoothness at the knots, the radix spline chooses a knot if the next point violates the given error bound and places it as late as possible. Using the above functions, splines can be constructed on large datasets.

These splines efficiently represent the cumulative distribution function (CDF) and provide smooth estimations with error guarantees.

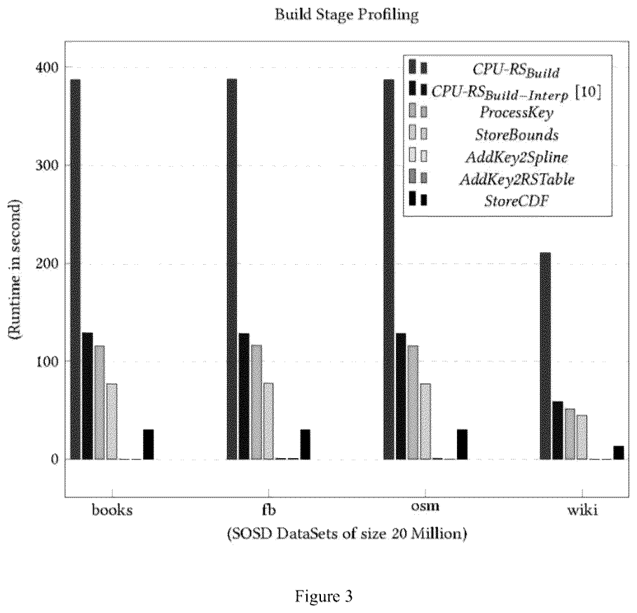

The present invention, in one embodiment, uses multipliers, adder-subtractor, and comparator modules to implement the spline interpolation operation on an FPGA. In this embodiment, the FPGA-based RS learned index architecture (see FIG. 1) consists of two major stages: Build and Lookup. The Build model (SMART-RS_{Build}) accelerates the build stage on an FPGA, while the Lookup model (SMART-RS_{Lookup}) executes the FPGA-based lookup acceleration. The build stage is first profiled. As of now, decision-making regarding the compute-intensive operation is performed offline. As shown in FIG. 3, for processing the SOSD dataset of size 20 million, different functions that were profiled are as follows:
CPU-RS_{Build}: The entire CPU-RS_{Build} stage.
CPU-RS_{Build-Interp}: Interpolation operation inside CPU-RS_{Build} stage.
ProcessKey: Process each key in the dataset,
AddKey2Spline: Update Spline points.
AddKey2RSTable: Update radix table.
StoreCDF: Store the CDF point.
StoreBounds: Set the lower and upper limit for the next key in the dataset.

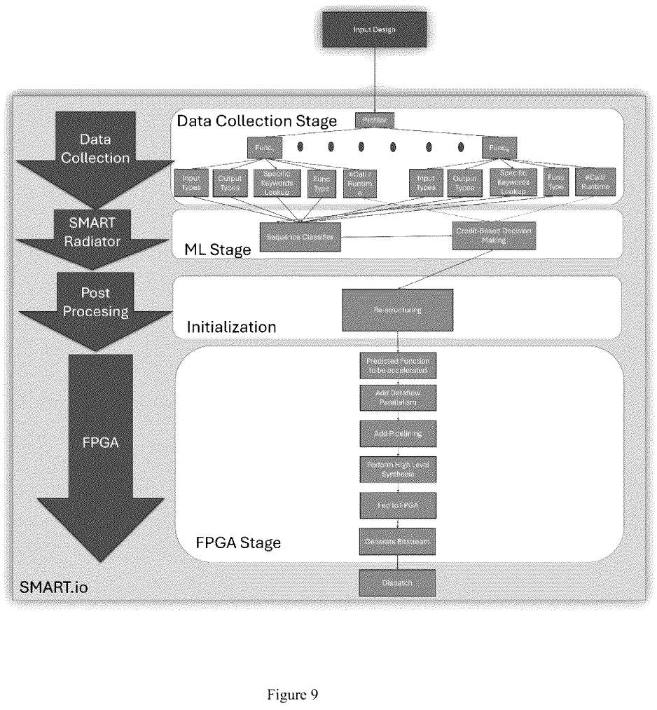

Amongst the various operations, interpolation is found to be the most compute-intensive. As the interpolation operation [10] took on average 50% of the total execution time of the build stage (FIG. 3), it is loaded onto an FPGA. In another embodiment, steps for identifying and selecting operations for loading onto an FPGA are described in further detail below with reference to FIGS. 9 to 13.

FPGA-based build stage accelerator model (SMART-RS_{Build}). In this stage, the index data is stored on a CPU while the interpolation operation is executed on an FPGA. As shown in FIG. 1, input to the FPGA-based SMART-RS_{Build} are: key, max spline error, and previously stored CDF point. Here, the X and Y coordinates are the bounding box of a spline. The FPGA-based build stage accelerator outputs the orientation type: clockwise (CW), counterclockwise (CCW), or collinear. Based on the orientation obtained, the upper and lower limits are set, and the previous CDF point is stored as the next spline point. RadixSpline is constructed over a sorted data set.

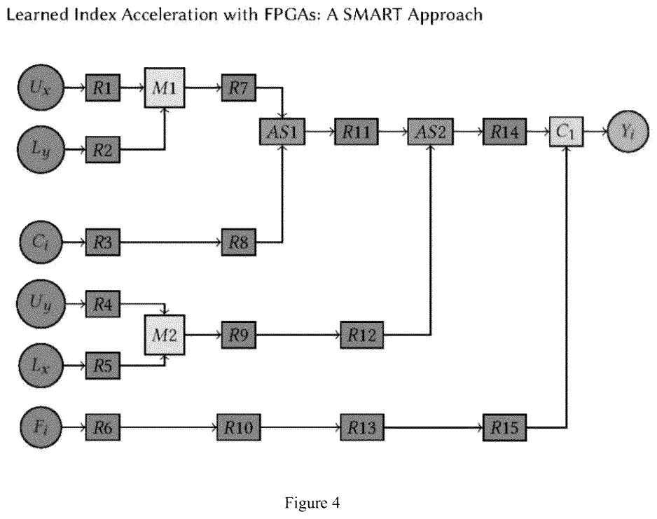

The module AddKeyToSpline iterates over the input sorted data set and will create the array of resultant splines as explained in Algorithm 1 below. Decision making in deciding the orientation type (Algorithm 2 below) is transferred to the module SMART-RS_{Build-Interp} on the FPGA. FIG. 4 shows the pipelined implementation of logic inside SMART-RS_{Build-Interp}. AS1 is AddSub1 and AS2 refers to the module AddSub2. Similarly, M1, M2 and C1 refer to Mult1, Mult2 and Comp1 operations, respectively. R* are the registers inserted for pipelining. previous CDF point is stored as the next spline point. RadixSpline is constructed over a sorted data set

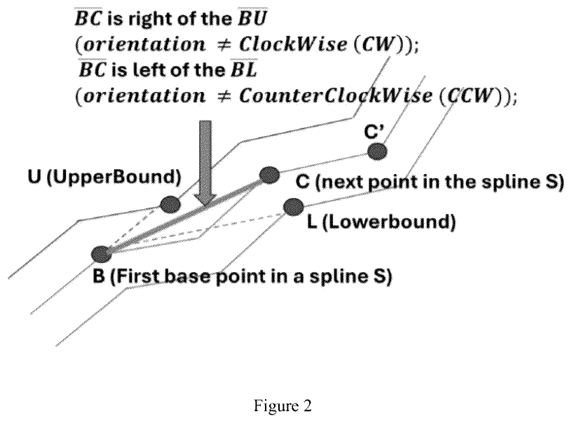

For a spline S, and a line segment B̅C̅ (FIG. 2), Uₓ, and U_{y} are the coordinates of the maximum error bound, while Lₓ, and L_{y} are the current error bound coordinates. Cᵢ is the constant and Fᵢ is the orientation type. Here, the sequence of operations first involves the multiplication of Uₓ and L_{y} data by multiplier M₁ as well as U_{y} and Lₓ data by multiplier M₂. This is then followed by the subtraction of the product M₁ from data Cᵢ, which is then followed by the subtraction of AS₁ from product M₂ and finally comparing (Comp1) the last output AS₂ with data Fᵢ.

The output from the FPGA is the type of orientation that makes the following decisions during spline construction:
store the input key and its position in the dataset in the spline points array (SplinePoints).
store the spline index in the radix table (RadixTable).
update the upper and lower error bounds

FPGA-based lookup stage accelerator model (SMART-RS_{Lookup}). In the lookup stage acceleration, the radix table and set of spline points are offloaded to the lookup-stage accelerator (SMART-RS_{Lookup}), where they are stored in BRAMs/SRLs as partitioned arrays. The size of the RadixTable and SplinePoints for different datasets are shown in Table 4. The SMART-RS_{Lookup} model then outputs the prediction bound range to calculate the location of the queried key.

### Algorithms

In one embodiment of the present invention, the algorithms used in the architecture of the present invention are explained below.

FPGA-based build stage accelerator (SMART-RS_{Build}). The first step of index construction is to build a radix spline model with the error rate not exceeding threshold max_error. In this step, the greedy spline interpolation algorithm [10] is utilized to ensure the optimal performance of the radix spline model. Details are shown in Algorithm 1 and Algorithm 2. First, the linear spline approximation is constructed for each error corridor. After that, the size of the error corridor is minimized.

Algorithm 1 iterates over the dataset and adds keys to the resultant spline. FIG. 2 illustrates the greedy spline corridor implementation in the first part of the spline construction. This stage aims to find the smallest resultant spline R that approximates the spline S within the error bounds. The first point in the spline S is the first base point B and is added to the R (line 3). The second point computes the upper and lower bounds (U, L) within the error bound ε (lines 4-5), and the point B is then added to the R as shown in Line 6. The module AddKeyToSpline then iterates over each point in the spline S linearly to determine if the line segment B̅C̅ between the base point and current point C lies within the bounds (U, L).

Algorithm 2 uses the maximum error bound, and current error bound to determine the type of orientation for a line segment between the base point and the current point. Maximum error bound and current error bound for the line segment B̅C̅ are computed in the Algorithm 2 (lines 2-3). The orientation type is calculated in line 5 of Algorithm 2. If the orientation is neither CW nor CCW (that is, the segment B̅C̅ either lies to the right of the segment B̅U̅ or left of the segment B̅L̅) (line 11), the previous point before Con the spline becomes the new base point B (line 12) and is added to R as shown in Line 13. The upper and lower bounds (U, L) are also incrementally updated based on the current spline point C (lines 14-15). If the orientation is either CW or CCW, only the bounds are updated as shown in Lines 17 and 18, and the new base point is not selected.

Upperbound is updated if the orientation is CW (line 21), whereas the lowerbound is updated if the orientation type is CCW (line 24). The last stored bound is replaced with the newer one, in case it is more restrictive. The last point in S that is within the error bounds is added to the resultant spline R as the final point.

Finally, the spline points selected are large enough to ensure that the interpolation error remains within the specified bound. These sets of spline points are then used to build the radix table as explained by Kipf et al. [7].

FPGA-basedlookupstageaccelerator(SMART-RS_{Lookup}). The radix table and spline points computed by the SMART-RS_{Build} model are then stored on the FPGA for lookup acceleration (SMART-RS_{Lookup}). GetSplineSegment explained in Algorithm 3 below returns the index of the spline points that mark the end of the segment that contains the queried key. The module GetEstimatedPosition, explained in Algorithm 4, computes the slope of the obtained spline segment and returns the estimated range (SplineStart, and SplineEnd) of the queried key (line 4 of Algorithm 4). The query key retrieves the two pointers (start and end) on the radix table. These pointers further narrow down the search range on the spline points. Finally, this range is returned from the FPGA-based lookup accelerator to the main function, where a binary search is performed on the original sorted dataset to obtain the key location.

Algorithm 1: SMART-RS_{Build} Index

| | Input: Sorted DataSet of size N > 0, ε : maxSplineError | | | |
|---|---|---|---|---|
| | Output: Resultant array of Spline R | | | |
| 1 | Function AddKey(key,index): | | | |
| 2 | \| | if key is first point in the spline S then | | |
| 3 | \| | \| | B = key; | |
| 4 | \| | \| | U = S[index + 1] + ε; | |
| 5 | \| | \| | L = S[index + 1] − ε; | |
| 6 | \| | \| | R =< B >; | |
| 7 | \| | \| | return R; | |
| 8 | \| | else | | |
| 9 | \| | \| | C = key; | |
| 10 | \| | \| | orientation.UpperBound = | |
| | \| | \| | SMART_{Build-Interp} (C,index,max_error); | |
| 11 | \| | \| | orientation.LowerBound = | |
| | \| | \| | SMART_{Build-Interp}(C,index,max_error); | |
| 12 | \| | \| | if orientation.UpperBound ≠ CW OR | |
| | \| | \| | orientation.LowerBound ≠ CCW then | |
| 13 | \| | \| | \| | B = S[index − 1]; |
| 14 | \| | \| | \| | R = R′ < B >; |
| 15 | \| | \| | \| | U = C + ε; |
| 16 | \| | \| | \| | L = C − ε; |
| 17 | \| | \| | else | |
| 18 | \| | \| | \| | U′ = C + ε; |
| 19 | \| | \| | \| | L′ = C − ε; |
| 20 | \| | \| | \| | orientation.UpperBound = |
| | \| | \| | \| | SMART_{Build-Interp}(C,index,max_error); |
| 21 | \| | \| | \| | orientation.LowerBound = |
| | \| | \| | \| | SMART_{Build-Interp}(C,index,max_error); |
| 22 | \| | \| | \| | if orientation.UpperBound == CW then |
| 23 | \| | \| | \| | \| U = U′; |
| 24 | \| | \| | \| | end |
| 25 | \| | \| | \| | if orientation.LowerBound == CCW then |
| 26 | \| | \| | \| | \| L = L′; |
| 27 | \| | \| | \| | end |

| | | | |
|---|---|---|---|
| 28 | \| | \| | end |
| 29 | \| | \| | R = R′ < S[N] >; |
| 30 | \| | \| | return R; |

| | | |
|---|---|---|
| 31 | \| | end |

| | |
|---|---|
| 32 | End Function |

Algorithm 2: SMART-RS_{Build-Interp} Index

| | Input: Key,Precision,CONST,ε : max_error; /* From | |
|---|---|---|
| | | sorted data set array */ |
| | Output: Orientation; /* Orientation can be CW, CCW | |
| | | or Collinear */ |
| 1 | Function | |
| | SMART_{Build-Interp}(n,previousCDFpoint,max_error): | |
| 2 | \| | {UpperBound_X,UpperBound_Y} = |
| | \| | computeUperBound( ); |
| 3 | \| | {LowerBound_X,LowerBound_Y} = |
| | \| | computeLowerBound( ); |
| 4 | \| | eval1 = (UpperBound_X × LowerBound_Y) − CONST; |
| 5 | \| | eval2 = (UpperBound_Y × LowerBound_X) − eval1; |
| | \| | Orientation = (eval2 > Precision) ? CW : (eval2 < |
| | \| | −Precision) ? CCW : Collinear; |
| 6 | \| | return Orientation; |

| | |
|---|---|
| 7 | End Function |

Algorithm 3: GetSplineSegment

| | Input: radix table (R_{table}), spline points (Sₚₒᵢₙₜ), minKey, | | |
|---|---|---|---|
| | | | maxKey, shiftBit, narrowRangeLimit, |
| | | | key to be queried, |
| | Output: currentIdx; /* End index of the spline | | |
| | | | segment containing the key */ |
| 1 | Function GetSplineSegment( ): | | |
| 2 | \| | radixIndex = (key − minKey) >> shiftBit; | |
| 3 | \| | SplineStartIdx = R_{table}[radixIndex]; | |
| 4 | \| | SplineEndIdx = R_{table}[radixIndex + 1]; | |
| 5 | \| | if | |
| | \| | SplineEndIdx − SplineStartIdx < narrowRangeLimit | |
| | \| | then | |
| 6 | \| | \| | currentIdx = SplineStartIdx; |
| 7 | \| | \| | while Sₚₒᵢₙₜ[currentIdx] < key do |
| 8 | \| | \| | \| currentIdx = currentIdx + 1; |
| 9 | \| | \| | end |
| 10 | \| | else | |
| | \| | \| | ;/* Do a binary search over a narrower |
| | \| | \| | range */ |

| | | |
|---|---|---|
| 11 | \| | end |
| 12 | \| | return currentIdx; |

| | |
|---|---|
| 13 | End Function |

### Experimental Evaluation

Below, the datasets and experimental settings used in the experiments are explained. Thereafter, the runtime acceleration of the SMART-RS architecture over CPU-RS is compared. CPU-PGM [4] is also used in the comparison as it is considered the first learned index to be introduced. Finally, the results achieved with the architecture according to an embodiment of the present invention are provided.

### Datasets

SOSD datasets [9] were used for the experiments. The SOSD benchmarks include different datasets, each of which consists of 200 million 64-bit unsigned integers (keys) with very few duplicates.

Table 2 shows the characteristics of the datasets that were used to evaluate the present system. These datasets have been used previously in various research [7-9] for evaluating the performance of various learned indexes.

Algorithm 4: GetEstimatedPosition

| | Input: radix table (R_{table}), spline points (Sₚₒᵢₙₜ), minKey, | |
|---|---|---|
| | | maxKey, shiftBit, narrowRangeLimit, |
| | | key to be queried, |
| | Output: pair(SplineStart,SplineEnd); /* Estimated | |
| | | position (SplineStart, and SplineEnd) of |
| | | the queried key */ |
| 1 | Function GetEstimatedPosition( ): | |
| 2 | \| | SplineStart = Sₚₒᵢₙₜ[GetSplineSegment( ) − 1]; |
| 3 | \| | SplineEnd = Sₚₒᵢₙₜ[GetSplineSegment( )]; |
| 4 | \| | return pair(SplineStart,SplineEnd); |

| | |
|---|---|
| 5 | End Function |

TABLE 2
SOSD Datasets

| Data | | | Key | Key | Key |
|---|---|---|---|---|---|
| Set | Representation | Size | Type | Size | Num |
| books | Book sale popularity | 1500 MB | int64 | 8B | 2 × 10⁸ |
| | data | | | | |
| fb | Upsampled version | 1500 MB | int64 | 8B | 2 × 10⁸ |
| | of a Facebook user | | | | |
| | ID dataset | | | | |
| osm | Uniformly sampled | 1500 MB | int64 | 8B | 2 × 10⁸ |
| | Open-StreetMap | | | | |
| | locations | | | | |
| | represented as | | | | |
| | Google S2 CellIds | | | | |
| wiki | Wikipedia article | 1500 MB | int64 | 8B | 2 × 10⁸ |
| | edit timestamps | | | | |

TABLE 3
Performance comparison between FPGA-RS_{Build} and SMART-RS_{Build} implementation on an FPGA.

| | FPGA-based Build Stage Accelerator (Full vs SMART acceleration) | | | | | | |
|---|---|---|---|---|---|---|---|
| Metric | FPGA-RS_{Build}: Entire Build Stage acceleration on FPGA | | | | | | SMART-RS_{Build} |
| DataSet Size | 10 | 10² | 10³ | 10⁴ | 10⁵ | 10⁶ | 200 million |
| Verilog Code Size | 6051 | 6051 | 6051 | 6051 | 6051 | 6051 | 661 |
| IO Port Usage | 500 | 500 | 500 | 500 | 500 | 500 | 294 |
| BRAM Usage | 4 | 4 | 4 | 96 | 392 | 3920 | 0 |
| DSP Usage | 9 | 9 | 9 | 9 | 9 | 13 | 17 |
| FF Usage | 5313 | 5340 | 5367 | 5411 | 5432 | 6295 | 1165 |
| LUT Usage | 11004 | 11027 | 11080 | 11376 | 11632 | 38300 | 1101 |
| Rent Exponent | 0.29 | 0.34 | 0.34 | 0.29 | 0.35 | 0.41 | 0.32 |
| Dynamic On-Chip | 0.014 | 0.014 | 0.014 | 0.018 | 0.035 | Fail: | 0.071 |
| Power (Watt) | | | | | | Over- | |
| | | | | | | utilized | |
| Static On-Chip | 3.615 | 3.615 | 3.615 | 3.615 | 3.626 | Fail: | 2.946 |
| Power (Watt) | | | | | | Over- | |
| | | | | | | utilized | |
| Minimum Latency | 1203 | 1300 | 13000 | 20008 | 34000 | Fail: | 11 |
| (cycles) | | | | | | Over- | |
| | | | | | | utilized | |
| Minimum Period | 60 | 60 | 60 | 60 | 60 | 60 | 5 |
| (ns) | | | | | | | |
| Fmax (Mhz) | 24.66 | 24.66 | 24.66 | 18.6 | 18.66 | Fail: | 227.27 |
| | | | | | | Over- | |
| | | | | | | utilized | |
| Place and Route | Pass | Pass | Pass | Pass | Pass | Fail: | Pass |
| Status | | | | | | Over- | |
| | | | | | | utilized | |
| FPGAs Required | 1 | 1 | 1 | 1 | 1 | 2 | 1 |
| (minimum) | | | | | | | |

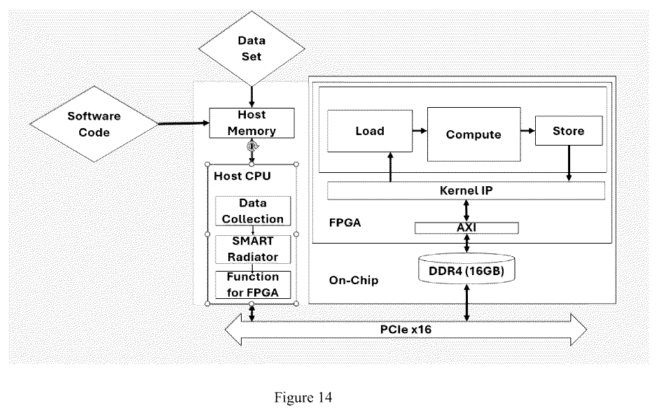

FIG. 14 is a block diagram depicting an exemplary embodiment of a compute-system which can be used to accelerate computer processing according to embodiments of the present method.

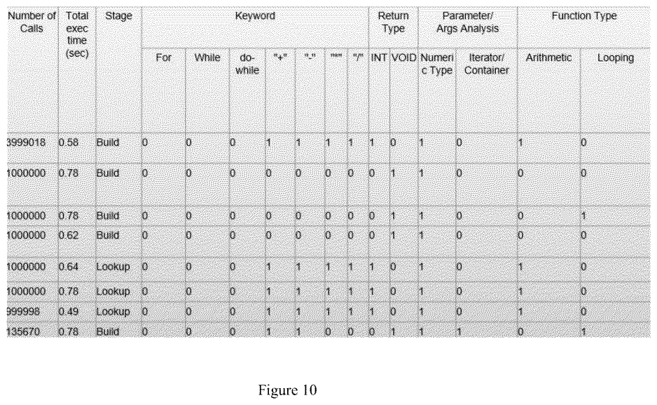

FIG. 9 is a flow diagram of SMART architecture according to an embodiment of the present invention that includes steps for FPGA-based acceleration of the processing a dataset. A data collection step includes extracting the specific characteristics of different modules (see Table 3A). A sub-step of the data collection step is a profiling step where various data, such as function call counts, execution times, and call graphs, are extracted. An example output of the profiling is displayed in FIG. 10.

TABLE 3A

| Descriptor | Description | |
|---|---|---|
| Return type | The data type returned by the function | |
| Parameters/args type | Data type of each paramter | |
| Function type | Semantic (static code) analysis if function is: | |
| | 1. | Arithmetic: Arithmetic operation |
| | 2. | Looping: Contains loops (for, while, do- |
| | | while) |
| | 3. | Io: performs input/output (like printf, |
| | | cin, cout) |
| | 4. | Initialization: mainly set up variables, |
| | | structures, and states. |
| | 5. | Recursive: function calls itself |
| | | (directly/indirectly) |
| | 6. | Conditional: contains branching (if- |
| | | else, switch, ternary operators) |
| Keyword type | Determine if: | |
| | 1. | Arithmetic: +, −, *, / |
| | 2. | Looping: for, while, do-while |

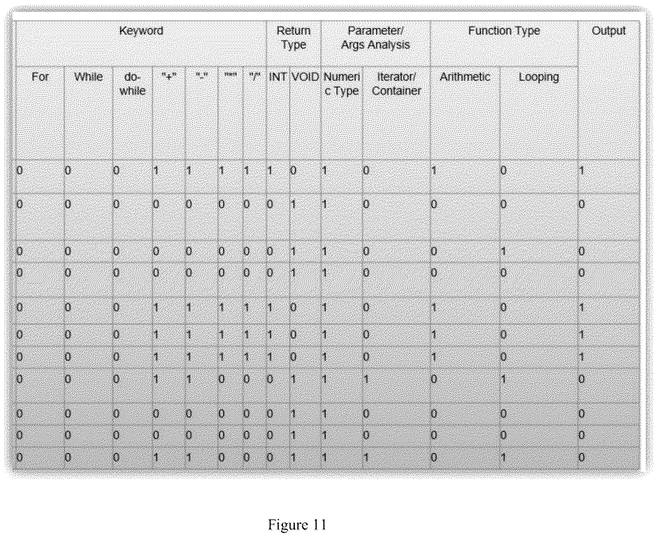

In the SMART Radiator step, machine learning is used to carry out sequence classification by taking profiling data as an input. In a sub-step, a machine learning (ML) model categorizes the data sequence into different classes and focuses on understanding the order and relationships between elements within a sequence. As shown in FIG. 11, the model is trained with a labeled binary output (0/1) to capture long-range dependencies in sequences effectively, where assigning a “0” value to a feature of a function means that the particular feature is not present in the software code being analysed, whereas assigning a “1” value to a feature of a function means that the particular feature is present in the software code being analysed.

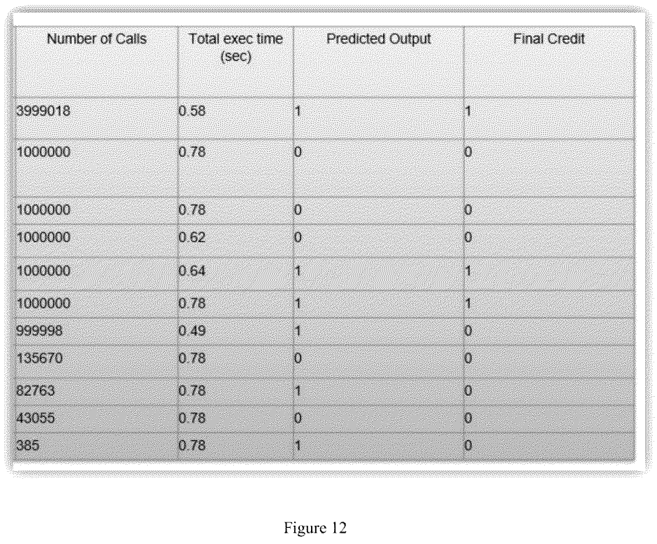

In a further sub-step of the SMART Radiator step, a credit-based decision-making step includes the trained output undergoing additional processing that incorporates the profiling data to arrive at a final decision. This process is detailed in FIG. 12, which illustrates how the integration of these elements enhances the accuracy and reliability of the decision-making process. The profiling data serves to refine and contextualize the trained output, ensuring that the final decision is well-informed and aligned with the specific criteria and requirements established in the analysis.

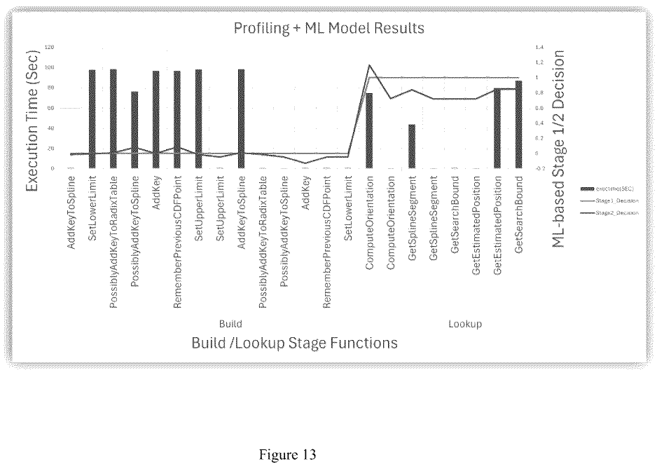

FIG. 13 shows the plot with Profiling and post-ML model prediction for different functions. The X-axis of the present analysis represents various functions performed during the build and lookup stages, while varying data sizes are also depicted. On the left y-axis, displayed is the execution time of each function as measured following the profiling stage, which provides a quantitative assessment of performance characteristics. The right y-axis illustrates the predictions made by the SMART Radiator engine after undergoing two distinct stages: the first stage involving the sequence classifier, and the second stage centered on the credit-based decision maker.

Despite the fact that the functions executed during the build stage exhibited nearly identical execution times according to the left y-axis, our machine learning model identified computeOrientation( ) as the single most compute-intensive function for acceleration on the FPGA. This indication suggests that, although the performance metrics are similar, there is a higher computational demand for computeOrientation( ) when optimizing for efficiency on FPGA hardware.

In the lookup stage, the machine learning model spotlighted two functions, GetEstimatedPosition( ) and GetSearchBound( ) as the most resource-intensive. This differentiation illustrates the model's ability to analyze and predict which functions will benefit most from hardware acceleration.

Based on these predictions, the acceleration of the computeOrientation( ) function during the “Build” stage on the FPGA was prioritized. This choice aims to enhance overall performance and efficiency, tailoring the approach to the specific demands identified by the predictive analytics.

The post processing step includes transforming the predicted compute-intensive function identified in the previous step into the primary module for the FPGA design process. This necessitates a thorough re-evaluation and restructuring of the original design concepts that were initially crafted for the “Data Collection” stage. The modifications made will allow for enhanced efficiency and performance tailored to the demands of the FPGA architecture. Consequently, the output of this comprehensive redesign process will be a “modified design” that not only meets the computational requirements but also integrates seamlessly with subsequent stages of development.

The FPGA step includes inserting the parallelism and making the design pipelined to enable high throughput by overlapping the execution of different operations.

### Hardware

The accelerator according to the present embodiment was implemented on an Alveo U250 data center accelerator card (xcu250) along with Vitis/Vivado 2022.1 version software. To benchmark it against the CPU, an Intel® Core™ i7-10700 CPU @ 2.90 GHz was used.

### Results

In this section, the results achieved with the present architecture (SMART-RS) are compared with CPU-RS and CPU-PGM learned index models. Comparison is made for both the build stage as well as the lookup stage of the RS index. Table 3 shows the performance comparison between the entire RS Index operation on the FPGA vs our SMART-RS_{Build} architecture with varying dataset sizes. The present model is 2.946 watts for a dataset of size 200 million, as compared to 3.73 watts for a dataset of size 10⁶. Furthermore, due to the lower Verilog code size (661 lines with the present model), the debugging time of simulation-related issues is significantly reduced.

FPGA-based build stage accelerator (SMART-RS_{Build}). Accelerating the entire Build stage of RS-Index on a single FPGA without any off-chip memory is hindered by over-utilization on the FPGA. The present inventors therefore followed the SMART approach to predict compute-intensive operations in the build stage of CPU-RS Index.

The FPGA-based build stage accelerator (SMART-RS_{Build}) has an average speedup of 1.5× over CPU-RS_{Build}.

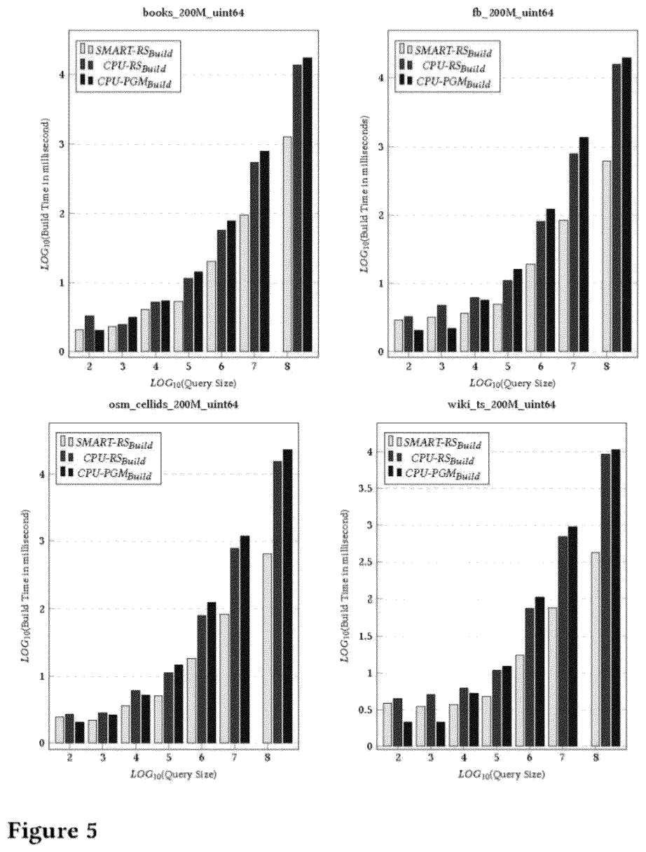

FIG. 5 shows the build time performance with three index models: SMART-RS_{Build}, CPU-RS_{Build} and CPU-PGM_{Build}.

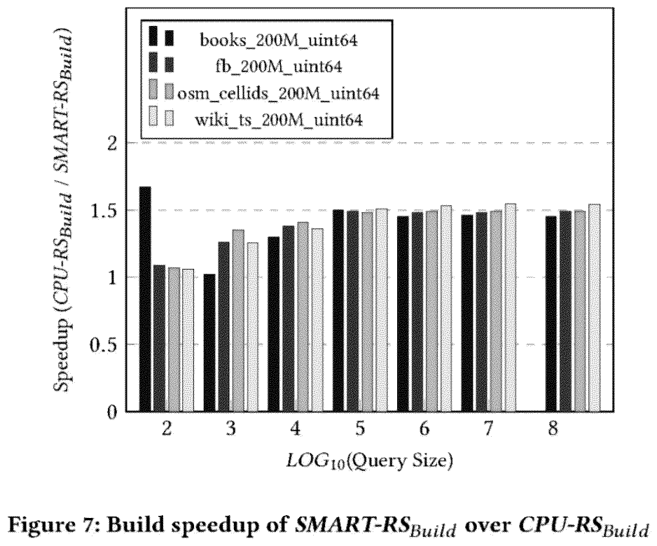

FIG. 7 shows the speedup achieved by SMART-RS_{Build} over CPU-RS_{Build} time on sorted SOSD datasets. For the larger datasets (greater than 10³), the SMART-RS_{Build} model performance improves by 1.5× compared to the CPU-RS_{Build} model. However, for smaller datasets, the performance improvement is 1.2×. This slight degradation in the case of the smaller dataset is attributed to the fact that the architecture and parameter settings are tuned to the larger datasets. The focus here is primarily on larger datasets.

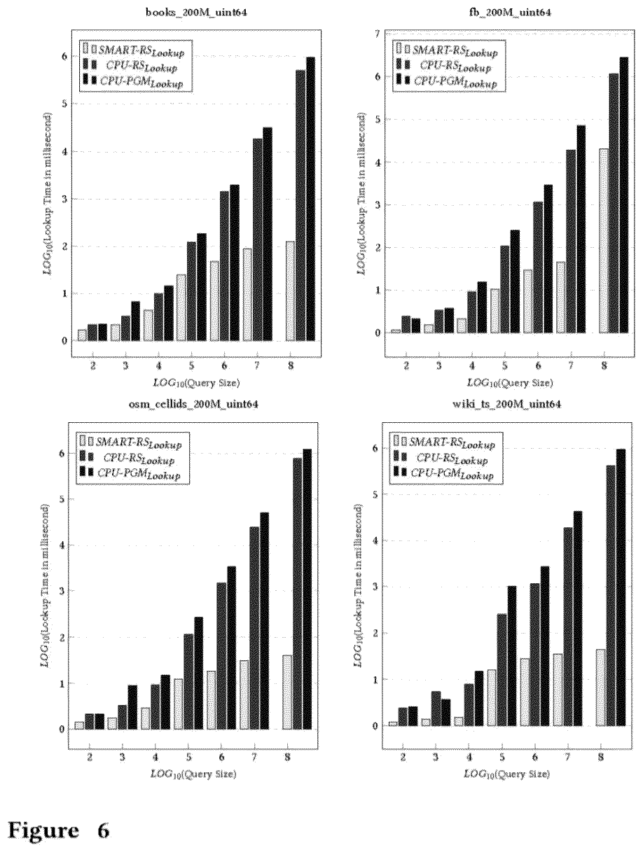

FPGA-basedlookupstageaccelerator(SMART-RS_{Lookup}). FIG. 6 shows the lookup time performance with three index models: SMART-RS_{Lookup}, CPU-RS_{Lookup} and CPU-PGM_{Lookup}. SMART-RS_{Lookup} achieves an average speedup of 4× over CPU-RS_{Lookup}.

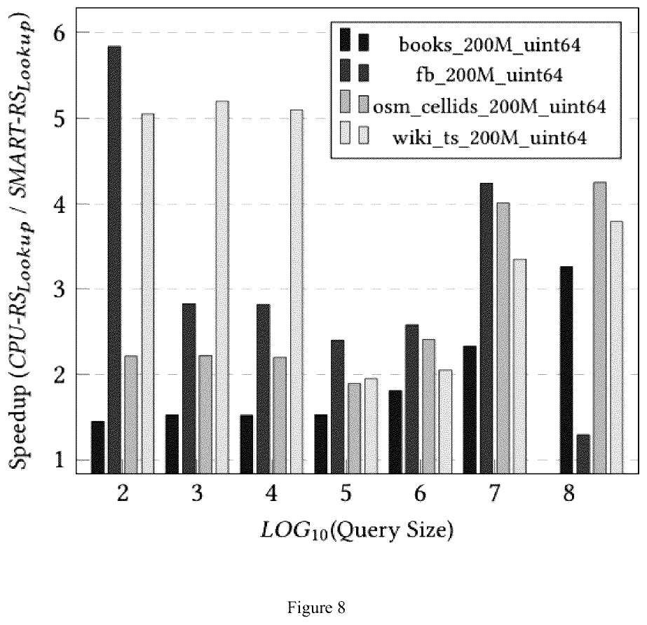

FIG. 8 shows the speedup achieved by SMART-RS_{Lookup} over CPU-RS_{Lookup}. With the present SMART methodology, we achieved an average 4× speedup for querying N keys in the data set of size N. Due to the dataflow-based lookup stage implementation, while the current input key key is being searched in an estimated range in the spline point array, the index of the spline segment containing the next queried key is being processed in the radix table. However, the speedup also depends upon the size of the data structures that are returned by the build accelerator (SMART-RS_{Build}). With varying sizes, the target frequency (Fmax) and optimization strategies (such as pipelining, dataflow, and expression balancing) require tuning to achieve maximum throughput. Table 5 provides the information on the size of data structure input to SMART-RS_{Lookup} accelerator.

Since the arrays must be specified with a constant size before high-level synthesis (HLS), the number mentioned in Table 4 needs to be defined explicitly during compile time.

Learned Index Acceleration with FPGAs: A SMART Approach

TABLE 4
Size of data structures for different dataset types and
dataset size. RadixTable and set of spline points generated
by the build stage. These data structures are the input to FPGA-
based lookup accelerator (SMART-RS_{Lookup})

| | Input to | | | | |
|---|---|---|---|---|---|
| | SMART- | DataSet Type | | | |
| Size | RS_{Lookup} | books | fb | osm | wiki_ts |
| 10² | Radix Table | 4937 | 99636 | 247340 | 247340 |
| | Spline Point | 2 | 3 | 3 | 2 |
| 10³ | Radix Table | 244067 | 185866 | 167313 | 167313 |
| | Spline Point | 3 | 8 | 13 | 5 |
| 10⁴ | Radix Table | 171688 | 235981 | 139397 | 173592 |
| | Spline Point | 4 | 70 | 68 | 22 |
| 10⁵ | Radix Table | 217091 | 136538 | 195 | 165132 |
| | Spline Point | 14 | 713 | 499 | 195 |
| 10⁶ | Radix Table | 135707 | 175350 | 208533 | 175341 |
| | Spline Point | 98 | 7182 | 4654 | 1378 |
| 10⁷ | Radix Table | 169574 | 232498 | 164962 | 142621 |
| | Spline Point | 978 | 71791 | 42661 | 5750 |
| 2 × 10⁸ | Radix Table | 131074 | 262145 | 194908 | 231025 |
| | Spline Point | 138352 | 2076200 | 1314914 | 202394 |

The present invention according to an embodiment relates to a method which the present inventors call SMART to accelerate the performance of learned indexes with an FPGA. An RS-based learned index was selected due to its high performance compared to other state-of-the-art learned index models. The experimental results with the present SMART architecture-based learned index acceleration with an FPGA showed that SMART-RS index significantly improved the query efficiency compared with CPU-RS index. The advantage of the present method is that the desired level of on-chip and off-chip memory resources can be utilized while accelerating the compute-intensive operations. This saves the FPGA area while at the same time accelerating the SMART-RS model. Another major advantage of the present method is the comparison between CPU and FPGA is more accurate. Accelerating the entire RS-index on an FPGA also involves RTL implementation of the learned index, which can be extremely complex and time-consuming. With the present SMART approach, only a specific compute-intensive module is customized instead of rewriting the entire code base for the FPGA. Reducing this complexity, in turn, also reduces the complexity of debugging RTL-related simulation issues. SMART approach significantly reduces IOs and RTL code size along with the area and power reduction. This speeds up the accelerator turnaround time.

While the teaching herein include illustrative embodiments and examples of some aspects of an invention, the description is not intended to be construed in a limiting sense. Thus, various modifications of the illustrative embodiments, as well as other embodiments of the invention, may be apparent to persons skilled in the art upon reference to this description. It is therefore contemplated that the appended claims will cover any such modifications or embodiments.

All publications, patents, and patent applications referred to herein are incorporated by reference in their entirety to the same extent as if each individual publication, patent, or patent application was specifically and individually indicated to be incorporated by reference in its entirety.

### REFERENCES

[1] Amazon. [n. d.]. Amazon EC2. https://aws.amazon.com/ec2/instance-types/f1/.
[2] Rajeev Bansal. 2017. Fundamentals of Numerical Methods. Chapter 4.13.
[3] Jae Min Cho and Kiyoung Choi. 2014. An FPGA implementation of highthroughput key-value store using Bloom filter. In Technical Papers of 2014 International Symposium on VLSI Design, Automation and Test. 1-4. https://doi.org/10.1109/VLSI-DAT.2014.6834868
[4] Paolo Ferragina and Giorgio Vinciguerra. 2020. The PGM-Index: A Fully-Dynamic Compressed Learned Index with Provable Worst-Case Bounds. Proc. VLDB Endow. 13, 8 (April 2020), 1162-1175.https://doi.org/10.14778/3389133.3389135
[5] Alex Galakatos, Michael Markovitch, Carsten Binnig, Rodrigo Fonseca, and Tim Kraska. 2019. FITing-Tree: A Data-Aware Index Structure. In Proceedings of the International Conference on Management of Data (Amsterdam, Netherlands) (SIGMOD '19), 1189-1206.https://doi.org/10.1145/3299869.3319860
[6] Zsolt István, Gustavo Alonso, Michaela Blott, and Kees Vissers. 2013. A flexible hash table design for 10GBPS key-value stores on FPGAS. In 2013 23rd International Conference on Field programmable Logic and Applications. 1-8. https://doi.org/10.1109/FPL.2013.6645520
[7] Andreas Kipf, Ryan Marcus, Alexander van Renen, Mihail Stoian, Alfons Kemper, Tim Kraska, and Thomas Neumann, 2020. RadixSpline: A Single-Pass Learned Index. In Proceedings of the Third International Workshop on Exploiting Artificial Intelligence Techniques for Data Management (Portland, Oregon) (aiDM '20). Article 5, 5 pages. https://doi.org/10.1145/3401071.3401659
[8] Tim Kraska, Alex Beutel, Ed H. Chi, Jeffrey Dean, and Neoklis Polyzotis, 2018. The Case for Learned Index Structures. In Proceedings of the International Conference on Management of Data (Houston, TX, USA) (SIGMOD '18). 489-504. https://doi.org/10.1145/3183713.3196909
[9] Ryan Marcus, Andreas Kipf, and Alex van Renen. 2019. Searching on Sorted Data, https://doi.org/10.7910/DVN/JGVF9A
[10] Thomas Neumann and Sebastian Michel. 2008. Smooth Interpolating Histograms with Error Guarantees. In Proceedings of the 25th British National Conference on Databases: Sharing Data, Information and Knowledge (Cardiff, Wales, UK) (BNCOD '08). 126-138. https://doi.org/10.1007/978-3-540-70504-8_12
[11] Patrick O'Neil, Edward Cheng, Dieter Gawlick, and Elizabeth O'Neil. 1996. The Log-Structured Merge-Tree (LSM-Tree). Acta Inf. 33, 4 (June 1996), 351-385. https://doi.org/10.1007/s002360050048
[12] Weikang Qiao, Licheng Guo, Zhenman Fang, Mau-Chung Frank Chang, and Jason Cong. 2022. TopSort: A High-Performance Two-Phase Sorting Accelerator Optimized on HBM-based FPGAs. arXiv:2205.07991 [cs.AR]
[13] Yunhui Qiu, Hankun Lv, Jinyu Xie, Wenbo Yin, and Lingli Wang. 2018. Ultra-Low-Latency and Flexible In-memory Key-Value Store System Design on CPU-FPGA. In 2018 International Conference on Field-Programmable Technology (FPT). 142-149. https://doi.org/10.1109/FPT.2018.00030
[14] Nikola Samardzic, Weikang Qiao, Vaibhav Aggarwal, Mau-Chung Frank Chang, and Jason Cong. [n. d.]. Bonsai: High-Performance Adaptive Merge Tree Sorting.
[15] In Proceedings of the ACM/IEEE 47th Annual International Symposium on Computer Architecture (Virtual Event) (ISCA '20). 282-294. https://doi.org/10.1109/ISCA45697.2020.00033
[15] Nathan Zhang, Matthew Feldman, and Kunle Olukotun, 2021. High performance lattice regression on FPGAs via a high level hardware description language. In 2021 International Conference on Field-Programmable Technology (ICFPT). 1-10. https://doi.org/10.1109/ICFPT52863.2021.9609893

1. A method for configuring a compute resource for accelerating the running of software code, the compute resource comprising a central processing unit (CPU), a field programmable gate array (FPGA), the method comprising the steps of:
executing on the CPU
a simulated running of the software code using a test dataset,
a semantic analysis algorithm to identify functions in the software code, and
a machine learning algorithm to identify feature types present in the functions, and based on the feature types present, flagging the functions as either FPGA-suitable or CPU-suitable, where the FPGA-suitable functions are the most compute-intensive of the functions.

2. The method of claim 1, further comprising outputting to a user the flagging of the FPGA-suitable and CPU-suitable functions.

3. The method of claim 1, further comprising configuring the FPGA to execute at least one of the flagged FPGA-suitable functions.

4. The method of claim 3, further comprising executing on the FPGA the at least one of the flagged FPGA-suitable functions.

5. The method of claim 4, further comprising executing on the CPU
all flagged FPGA-suitable functions not being executed on the FPGA, and
the CPU-suitable functions.

6. The method of claim 5, wherein the feature types comprise an arithmetic operation and a looping operation.

7. The method of claim 6, wherein at least one of the flagged FPGA-suitable functions executed on the FPGA is an FPGA-suitable function wherein the arithmetic operation is present and the looping operation is not present.

8. The method of claim 6, wherein the at least one of the flagged FPGA-suitable functions executed on the FPGA is an interpolation function.

9. The method of claim 6, wherein the software code is for an application selected from the group consisting of a learned index, a learned join, a lightweight learned join, a learned join open, a compression-based index and a database query acceleration.

10. A configurable compute resource for accelerating the running of software code, the compute resource comprising:
a central processing unit (CPU), and
a field programmable gate array (FPGA), where the FPGA is configured to execute the at least one of the flagged FPGA-suitable functions according to claim 1.
